(19) United States
(12) Patent Application Publication
(10) Pub. No.: US 2024/0377838 A1
(43) Pub. Date: Nov. 14, 2024

(54) METHOD AND DEVICE FOR ENTERING AND EXITING AN ECONOMY OPERATING MODE FOR A TWIN-ENGINE AIRCRAFT

(71) Applicant: AIRBUS HELICOPTERS, Marignane Cedex (FR)

(72) Inventors: Marc GAZZINO, Marseille (FR); Antonin PREVOST, Aix-En-Provence (FR)

(73) Assignee: AIRBUS HELICOPTERS, Marignane Cedex (FR)

(21) Appl. No.: 18/442,395

(22) Filed: Feb. 15, 2024

(30) Foreign Application Priority Data
May 9, 2023 (FR) 2304589

(51) Int. Cl. G05D 1/644; B64D 31/00; G05D 109/25

(52) U.S. Cl. CPC G05D 1/644; B64D 31/00; G05D 2109/25

(57) ABSTRACT

A method for controlling an economy operating mode for an aircraft comprising two heat engines, only one of the heat engines being active and supplying mechanical power to the rotor in the economy operating mode. Operating parameters of the aircraft are measured and then compared with functional and safety limitations relating to the economy operating mode. When the aircraft is in the economy operating mode, if a functional limitation is not being respected by one of the parameters, an alert indicating the proximity of the functional limitations is issued in order to inform the pilot, and, if one of the safety limitations is not being respected, the economy operating mode is disengaged, each heat engine not supplying mechanical power to the at least one rotor being started.

### CROSS-REFERENCE TO RELATED APPLICATIONS

This application claims priority to French patent application No. FR 23 04589 filed on May 9, 2023, the disclosure of which is incorporated in its entirety by reference herein.

### TECHNICAL FIELD

The present disclosure lies in the field of systems for assisting the piloting of an aircraft.

The present disclosure relates to a method and a device for entering and exiting an economy operating mode for a twin-engine aircraft.

The present disclosure is intended for rotary-wing aircraft provided with at least two heat engines and at least one rotor, the heat engines rotating the respective rotor or rotors of these aircraft.

### BACKGROUND

Such a rotary-wing aircraft comprises at least one rotor that can be rotated by at least two heat engines. The heat engines are also over-dimensioned in order to allow the rotor to be driven with a single engine in the event of another engine failing. Such an aircraft comprises an operating mode referred to as “total” operating mode or “AEO”, which stands for “All Engines Operating”, wherein each heat engine supplies non-zero mechanical power to the at least one rotor, the heat engines then together supplying the required mechanical power to the at least one rotor in a substantially symmetrical manner.

In order to reduce the fuel consumption of the aircraft heat engines, an operating mode referred to as an “economy” operating mode may be used, principally during a cruising flight phase. In this economy operating mode, a single heat engine is active and supplies the power required to rotate the rotor of the aircraft. The other heat engine or engines are passive, and do not supply significant mechanical power, or indeed do not supply any power. This economy operating mode therefore involves asymmetrical operation of the heat engines, as the heat engines do not operate in an identical manner.

Such an economy operating mode is advantageous but needs to be used carefully. Indeed, the economy operating mode may make it possible to save on fuel consumption and directly reduce the cost of the flight or its environmental footprint, or improve the performances of the aircraft by increasing the aircraft range or its transportable weight. However, the economy operating mode may be limited to a certain flight envelope, to ensure that flight safety is always guaranteed and to ensure that the power plant supplies the power required for the current flight phase.

For example, the economy operating mode needs to be engaged with a minimum safety height in relation to the overflown ground in order to enable another engine to be reactivated in the event of failure of the engine driving the rotor.

According to another example, during high-speed forward flight phases, the aircraft requires a significant amount of driving power, that cannot be supplied in the economy operating mode without the risk of specific damage to the heat engine and/or the mechanical transmission channel, this damage being likely to give rise to additional maintenance costs.

Furthermore, the economy operating mode results in a reduction in the speed of the aircraft, thereby increasing the flight time and, consequently, the operating cost of this flight.

In such cases, the costs resulting from the increased flight time and/or from the additional maintenance costs may be greater than the saving obtained with the reduction in fuel consumption or the improvement in the performances of the aircraft.

According to another example, the performance of a heat engine fluctuates depending on the conditions under which the aircraft is operating, such as the wind, external temperature or altitude. These conditions may influence the power produced by the heat engine and/or its fuel consumption. As a result, using the economy operating mode in these conditions may prove less economical than a traditional operating mode of the heat engines in flight, or even impossible.

Therefore, choosing whether or not to use such an economy operating mode is a complex technical problem, in terms of both safety considerations and economic issues for the operator of the aircraft.

Documents US 2020/0362754, EP 3 738 888 and WO 2022/029581 describe the management of an economy operating mode for a rotorcraft provided with several heat engines. According to these documents, in this economy operating mode, at least one of the engines is an active engine supplying the driving power required by the rotorcraft and at least one other engine is on standby, supplying little or no driving power to the rotorcraft.

According to documents US 2020/0362754 and EP 3 738 888, the engine on standby may possibly be idling, or operating at a speed of rotation slower than idle speed. In order to enter or exit this economy operating mode, various operating parameters of the engines and/or the rotor of the rotorcraft need to be either within predetermined ranges, or below or above predetermined thresholds. Furthermore, in the event that additional power is necessary or in the event that the power supplied by the active engine drops, following a failure, for example, the engine on standby can supply additional power, or indeed its full power.

Document WO 2022/029581 describes conditions for switching between an AEO operating mode and the economy operating mode. The economy operating mode can be used in a limited flight envelope of the aircraft, in particular when it is in a zone free of obstacles or flight restrictions. The forward speed of the aircraft and the speed of rotation of its rotor need to lie within defined ranges. The altitude and the height of the aircraft in relation to the ground, as well as the torque delivered by the engines, also have an influence on whether the economy operating mode is authorized. The operating state and/or the failure of the aircraft systems and equipment are also taken into account in order to authorize the economy operating mode.

Documents US 2020/0388092, US 2020/0255159 and WO 2022/029581 describe the asymmetrical operation of aircraft provided with at least two engines driving one or more rotors, wherein at least one first engine operates in active mode to supply driving power to the rotors and at least one second engine operates in standby mode to supply no driving power to the rotors.

According to document US 2020/0388092, asymmetrical operation can be engaged at the request of an operator or automatically. During asymmetrical operation, if the aircraft needs an increase in power, the second engine may be made to supply more power than in the standby mode, and possibly to return immediately to high power. Various information on the operation of the aircraft may be displayed for a pilot, for example the output power of the engines and a target range indicator.

According to document US 2020/0255159, following receipt of confirmation of availability of an engine for asymmetrical operation and as a function of a set of engine parameters of the aircraft, an availability message is transmitted to a cockpit of the aircraft. Next, when a request initiated by the pilot to use this asymmetrical operation is received, the engines are commanded to operate in asymmetrical operation. When one or more of these parameters no longer satisfies the conditions for asymmetrical operation, it is deactivated.

According to document WO 2022/029581, parameters associated with the operating conditions of the aircraft are detected, these parameters comprising parameters indicative of the behavior of the engines and the positions of the controls imposed by the pilot on the rotors. Next, the aircraft transition from the first configuration to the second configuration takes place when the parameters take on predetermined values. In standby mode, the second engine is not stopped, but rotates an output shaft without supplying driving power to this output shaft. Series of messages are displayed for the crew, in order to indicate whether the requisite conditions are met or, on the contrary, are not met.

### SUMMARY

The aim of the present disclosure is therefore to propose an alternative method and system for controlling the implementation of such an economy operating mode in order to optimize and make safe the use of this economy operating mode.

The present disclosure therefore relates to a method and a system for controlling the economy operating mode for an aircraft comprising at least two heat engines, in order to manage the entry in and exit of this economy operating mode during a flight.

First and foremost, the present disclosure relates to a method for controlling an economy operating mode for an aircraft provided with at least one rotor, and at least two heat engines rotating the at least one rotor, the aircraft having a controller configured to control the heat engines in at least the economy operating mode wherein at least one active engine from among the heat engines supplies non-zero mechanical power to the at least one rotor and at least one passive engine from among the heat engines does not supply mechanical power to the at least one rotor. The method comprises the following steps:
measuring operating parameters of the aircraft by means of sensors;
using a calculator to compare the operating parameters of the aircraft with safety limitations and functional limitations relating to the economy operating mode;
if the aircraft is in the economy operating mode and at least one of the functional limitations is not being respected and said safety limitations are being respected, issuing an alert indicating that the functional limitations of the economy operating mode have been exceeded; and
if the aircraft is in the economy operating mode and at least one of the safety limitations is not being respected, disengaging the economy operating mode, the disengagement comprising the activation of the at least one passive engine by means of the controller.

The method according to the disclosure therefore makes it possible to manage the exit of the economy operating mode during the flight of the aircraft, in order to make the flight of the aircraft and the use of this economy operating mode safe.

The method according to the disclosure can therefore advantageously be used to assist the pilot of the aircraft in managing the use of this economy operating mode during the flight.

Indeed, this economy operating mode is to be used in a limited flight envelope specific to this economy operating mode, that is likely to make its use complex or even counter-productive from an economic point of view.

To this end, this method can be used to compare operating parameters of the aircraft with the safety and functional limitations characterizing the limited flight envelope of the aircraft in the economy operating mode. At least one operating parameter is compared with a functional limitation and at least one operating parameter is compared with a safety limitation.

The operating parameters of the aircraft make it possible, in particular, to define a current state of operation of the aircraft and its equipment, for example its power plant and rotors, and current characteristics of its flight. The operating parameters of the aircraft may also comprise meteorological parameters.

The limitations of the economy operating mode are on two levels and comprise functional limitations and safety limitations. The safety limitations have a direct effect on the safety of the flight of the aircraft. It is therefore essential to respect these safety limitations in order to avoid placing the aircraft in a high-risk position. The functional limitations have an effect on the operation of the aircraft or on the effectiveness of the economy operating mode. Failure to respect one or several functional limitations results, for example, in the loss of a non-safety function of the aircraft and/or may result in no saving, possibly in terms of fuel consumption and/or financial savings.

Therefore, when the aircraft is applying the economy operating mode, as soon as at least one of the functional limitations is not being respected by one of the operating parameters of the aircraft, while at the same time all of the safety limitations are being respected, an alert is issued indicating that the functional limitations of the economy operating mode have been exceeded.

This alert indicating that the functional limitations have been exceeded may be issued in the form of a message displayed on a display device of the aircraft. For example, the displayed message comprises information relating to the at least one flight and operating parameter not respecting the associated functional limitation, in order to inform the pilot of the aircraft.

The failure to respect a functional limitation may indicate that the use of the economy operating mode is not optimized and/or that the margin of the parameter in question with respect to a safety limitation is narrowing. The pilot may then act on the controls, immediately or after performing the maneuver that is under way, in order to ensure that the functional limitations are respected once more.

Moreover, as soon as a safety limitation is not being respected, irrespective of whether the functional limitations are being respected, the economy operating mode is automatically disengaged in order to place the aircraft in a safe flight envelope. During this disengagement of the economy operating mode, the passive engine or engines are automatically activated by means of the controller for safety reasons.

Activating a passive engine may consist in starting such a passive engine if it was stopped and not supplied with fuel.

Activating a passive engine may consist in accelerating this passive engine if it was started but, for example, running at an idle rating.

In any case, activating a passive engine enables it to supply non-zero mechanical power in order to rotate the at least one rotor.

Therefore, the method according to the disclosure advantageously makes it possible, during a flight phase implementing the economy operating mode, to warn the pilot if there is a failure to respect at least one functional limitation, in order to give him or her the possibility of optimizing the operation of the aircraft, and to automatically exit this economy operating mode if there is a failure to respect at least one safety limitation, in order to continue the flight safely.

The method for controlling an economy operating mode according to the disclosure may further comprise one or more of the following features, taken individually or in combination.

According to another possibility compatible with the preceding possibilities, the method may comprise normal starting and accelerated starting of the passive engine or engines in the economy operating mode in order to disengage the economy operating mode and exit this economy operating mode, this or these heat engines then being able to supply non-zero mechanical power to the rotor.

Normal starting and accelerated starting may be applied both to a passive engine that is stopped and not supplied with fuel, and to a passive engine that is started, for example running at an idle rating.

Normal starting may, for example, comprise a first acceleration referred to as “normal” acceleration applied to a passive engine, the first acceleration being carried out during a first time period until this or these heat engines supply non-zero mechanical power to the rotor, or indeed the power required for this heat engine.

Accelerated starting may, for example, comprise a second acceleration referred to as “short” acceleration applied to a passive engine, the second acceleration being carried out during a second time period until this or these heat engines supply non-zero mechanical power to the rotor, or indeed the power required for this heat engine. The second time period is shorter than the first time period. Accelerated starting therefore advantageously makes it possible to start the passive engine or engines concerned more quickly than normal starting.

Normal starting may take place following the issuing of an alert indicating that the functional limitations of the economy operating mode have been exceeded, if a pilot of the aircraft commands the exit of the economy operating mode by means of a human-machine interface.

Accelerated starting may take place following the failure to respect at least one safety limitation, during the disengagement of the economy operating mode, and more specifically for the activation of each passive engine.

According to another possibility compatible with the preceding possibilities, the operating parameters of the aircraft may comprise several parameters, including:
propulsion parameters relating to an assembly of the aircraft, the assembly comprising the heat engines, the at least one rotor, and a mechanical transmission channel mechanically connecting the heat engines and the at least one rotor; the propulsion parameters are chosen, for example, from torques, speeds of rotation at rotating members of the heat engines, a torque and a speed of rotation of a mast of the at least one rotor, and torques, speeds of rotation at rotating members of the mechanical transmission channel, margins relating to the performances of the heat engines and, in particular, relating to the available power, internal temperatures of the heat engines, counters referred to as “engine counters” associated with the heat engines, each engine counter counting an item of usage data of one of the heat engines, and counters referred to as “transmission counters” associated respectively with shafts of the mechanical transmission channel mechanically connected respectively to the heat engines, each transmission counter counting an item of usage data of one of the shafts;
flight parameters of the aircraft chosen from a forward speed, a rate of climb, an altitude, an attitude, a height in relation to the overflown ground;
operational parameters of the aircraft, the operational parameters being chosen, for example, from controlled pitch values of blades of the at least one rotor, a forward speed that is acceptable in the economy operating mode, the state of an item of equipment, such as an electric motor, a starter or a starter-generator connected to one of the heat engines, or indeed an electric battery, the state of an item of equipment comprising a “normal operating” state, a “stopped” state and a “malfunction present” state relating to this item of equipment; and
environmental parameters relating to traffic conditions around the aircraft and to weather conditions comprising, for example, an external temperature and an atmospheric pressure outside the aircraft, the presence of strong wind, rain or snow, or indeed the visibility conditions.

The usage data relating to a heat engine help characterize the use of and/or the damage to this heat engine. An engine counter may, for example, count the hours of operation of the heat engine, the creep damage it has undergone, and the numbers of cycles of a gas generator and a free turbine of a turboshaft engine.

The usage data relating to an input shaft of the mechanical transmission channel help characterize the use of and/or the damage to this input shaft. A transmission counter may, for example, count the number of cycles or the number of hours of operation of an input shaft or indeed a duration of use of this input shaft in the economy operating mode.

Moreover, the safety and functional limitations may comprise at least one propulsion limitation relating to at least one propulsion parameter, at least one flight limitation relating to at least one flight parameter, at least one operational limitation relating to at least one operational parameter and at least one environmental limitation relating to at least one environmental parameter.

These safety and functional limitations as a whole therefore form the limited envelope authorized for the economy operating mode.

A safety and functional limitation may comprise an upper threshold, an operating parameter respecting this limitation if the value of this parameter is less than this upper threshold.

A safety and functional limitation may comprise a lower threshold, an operating parameter respecting this limitation if the value of this parameter is greater than this lower threshold.

A safety and functional limitation may comprise a range within which the value of the flight and operating parameter must lie in order to respect this limitation.

A safety and functional limitation may also be associated with an operating parameter referred to as a “state” parameter. Such a state parameter can take at least two different values. Such a limitation is, for example, respected when the state parameter is in a first state and not respected when the parameter is in a second state. A state parameter may, for example, characterize an operating state of an item of equipment and comprise a “normal operating” state, a “stopped” state or a “malfunction present” state relating to this item of equipment.

Moreover, some of these limitations, whether they are safety or functional limitations, may comprise hysteresis thresholds in order to prevent the economy operating mode from being repeatedly engaged and disengaged in an untimely manner.

For example, a safety or functional limitation may comprise a lower hysteresis threshold that has a first threshold and a second threshold, the second threshold being greater than the first threshold. This limitation is therefore considered to be respected as long as the value of the operating parameter is greater than the second threshold. The value of the parameter is also greater than the first threshold in this case. This limitation is also considered to be respected when the value of the operating parameter drops below the second threshold while remaining greater than the first threshold.

As soon as the value of the parameter drops below the first threshold and the second threshold, the limitation is considered not to be respected and continues to be considered not to be respected as long as the value of the parameter is less than the second threshold, i.e., even once the value of the parameter is greater than the first threshold. The limitation is considered to be respected again once more as soon as the value of the parameter is greater than the second threshold, and therefore also greater than the first threshold.

According to another possibility compatible with the preceding possibilities, if the aircraft is not in the economy operating mode and the functional and safety limitations are being respected by the operating parameters, the method may comprise issuing information relating to the availability of the economy operating mode. This information is used to inform the pilot of the aircraft that the functional and safety limitations relating to the economy operating mode are being respected and that the aircraft can therefore use this economy operating mode without risk and effectively to reduce fuel consumption and, consequently, the operating cost of the flight. Once this information has been issued, the pilot can then decide, via a human-machine interface, to command the engagement of the automatic operating mode.

This issuing of information relating to the availability of the economy operating mode may comprise displaying a message on a display device of the aircraft, issuing a sound with a loudspeaker or emitting a vibration with a haptic device.

Alternatively, if the aircraft is not in the economy operating mode and the functional and safety limitations are being respected by the operating parameters, the method may comprise engaging the economy operating mode. This engagement of the economy operating mode takes place, for example, automatically if the pilot has previously selected such a possibility via a suitable human-machine interface.

The step of engaging the economy operating mode may comprise a first control of at least one of the heat engines by means of the controller so that it is an active engine and supplies the required mechanical power to the at least one rotor, and a second control of at least one other of the heat engines by means of the controller so that it is a passive engine supplying no mechanical power to the at least one rotor. The second control comprises, for example, stopping or idling one or more of the other heat engines by means of the controller.

Moreover, the calculator may determine which of the heat engines can or needs to be an active engine and which of the heat engines can or needs to be a passive engine for the economy operating mode. The calculator then transmits information to the controller relating to the active engine for the first control and to the passive engine for the second control.

This information may, for example, be used to alternate several active engines over several successive flights, or indeed over a single flight, in order to balance the duration of use of and damage to the heat engines and the associated input shafts of a mechanical gearbox to which each heat engine is connected. This information may be determined as a function of the propulsion parameters relating to the aircraft as a whole, and in particular the usage data relating to the heat engines and to the mechanical transmission channel, supplied respectively by the engine counters and by the transmission counters. This makes it possible to optimize the maintenance of the heat engines and the mechanical transmission channel, the maintenance of the two engines being able to be carried out simultaneously, for example.

This information may in particular be used during the step of engaging the economy operating mode in order to define the heat engines to which the first control and the second control respectively need to be applied.

According to another possibility compatible with the preceding possibilities, the method may comprise a display step with a display device, such as a screen, in order to display one or more operating parameters and the associated functional and safety limitations. As a result, the pilot of the aircraft can at any time view information relating to the position of these parameters in relation to their respective limitations, and decide whether or not the pilot can use the economy operating mode.

According to another possibility compatible with the preceding possibilities, the controller may comprise as many engine controllers as the aircraft comprises heat engines, each engine controller being dedicated to a single heat engine in order to manage, control and monitor its operation. Each engine controller makes it possible, for example, to store the engine counters of a heat engine in a memory and increment them during the operation of the heat engines.

Such an engine controller is, for example, an EECU or Electronic Engine Control Unit, or may be part of an FADEC or Full Authority Digital Engine Control system.

According to another possibility compatible with the preceding possibilities, the economy operating mode may comprise a first operating mode, wherein the passive engine is stopped and not supplied with fuel, and a second operating mode, wherein the passive engine is started and supplied with fuel, without supplying mechanical power to the at least one rotor.

An aircraft may have both of the economy operating modes or only one of these two economy operating modes.

Furthermore, some limitations, whether they are functional or safety limitations, may be different for the first operating mode and the second operating mode.

Therefore, at least one of the functional limitations may comprise a first functional limitation relating to the first operating mode and a second functional limitation relating to the second operating mode, the first functional limitation and the second functional limitation then being associated with the same operating parameter. Similarly, at least one of the safety limitations may comprise a first safety limitation relating to the first operating mode and a second safety limitation relating to the second operating mode, the first safety limitation and the second safety limitation then being associated with the same operating parameter.

If the aircraft is in the first operating mode and at least one of the first functional limitations is not being respected and the second functional limitations are being respected, the first and second safety limitations being respected, a step of issuing an alert indicating that the first functional limitations have been exceeded may be carried out. This alert may be visual, in the form of a displayed message informing the pilot of which operating parameter is not respecting the first functional limitation, or indeed audio or haptic.

In these conditions, alternatively or additionally, a step of engaging the second operating mode may be carried out automatically if a human-machine interface is actuated or has previously been actuated by a pilot of the aircraft. This engagement step may comprise starting the passive engine or engines that were stopped in this first operating mode, without them supplying mechanical power to the at least one rotor. This starting step is carried out by means of the controller.

If the aircraft is in the first operating mode and at least one of the first safety limitations is not being respected and the second safety limitations are being respected, a step of engaging the second operating mode may be carried out automatically. This engagement step may comprise starting the passive engine or engines that were stopped in this first operating mode, without them supplying mechanical power to the at least one rotor. This starting step is carried out by means of the controller.

The first time period relating to the abovementioned normal starting may be different for the first operating mode and the second operating mode. This first time period is, for example, longer for the first operating mode than for the second operating mode. The first time period may be equal to 30 seconds for the first operating mode and 20 seconds for the second operating mode.

Similarly, the second time period relating to the abovementioned accelerated starting may be different for the first operating mode and the second operating mode. This second time period is, for example, longer for the first operating mode than for the second operating mode. The second time period may be equal to 10 seconds for the first operating mode and 5 seconds for the second operating mode.

The present disclosure also relates to a computer program comprising instructions that, when the program is run, result in the implementation of the method according to the disclosure described above. The program is, for example, run by a calculator or a computer embedded on the aircraft, comprising at least one processor, at least one integrated circuit, at least one programmable system, at least one logic circuit, and a memory, these examples not limiting the scope given to the expression “calculator” or “computer”.

The memory can be used to store the computer program and different information used by the computer program, i.e., the safety and functional limitations, as well as operating parameters of the aircraft, for example meteorological parameters.

The present disclosure also relates to a system for controlling an economy operating mode for an aircraft provided with at least one rotor, and at least two heat engines rotating the at least one rotor, the aircraft having a controller configured to control the heat engines in an economy operating mode wherein at least one active engine from among the heat engines supplies mechanical power to the at least one rotor and at least one passive engine from among the other heat engines does not supply mechanical power to the at least one rotor. This control system comprises at least one calculator, and at least one memory storing instructions. The system for controlling an economy operating mode is connected to the controller of the heat engines and is configured to implement the method described above by means of these instructions.

The control system is embedded on the aircraft and is connected to the controller of the heat engines by a wireless or wired link. The control system may comprise a display device, such as a screen, for displaying, in particular, an alert message.

The present disclosure finally relates to an aircraft comprising such a control system.

### BRIEF DESCRIPTION OF THE DRAWINGS

The disclosure and its advantages appear in greater detail in the context of the following description of embodiments given by way of illustration and with reference to the accompanying figures, wherein:

FIG. 1 shows an aircraft provided with a system for controlling an economy operating mode; and

FIG. 2 is an overview diagram of a method for controlling an economy operating mode for an aircraft.

### DETAILED DESCRIPTION

Elements that are present in more than one of the figures are given the same references in each of them.

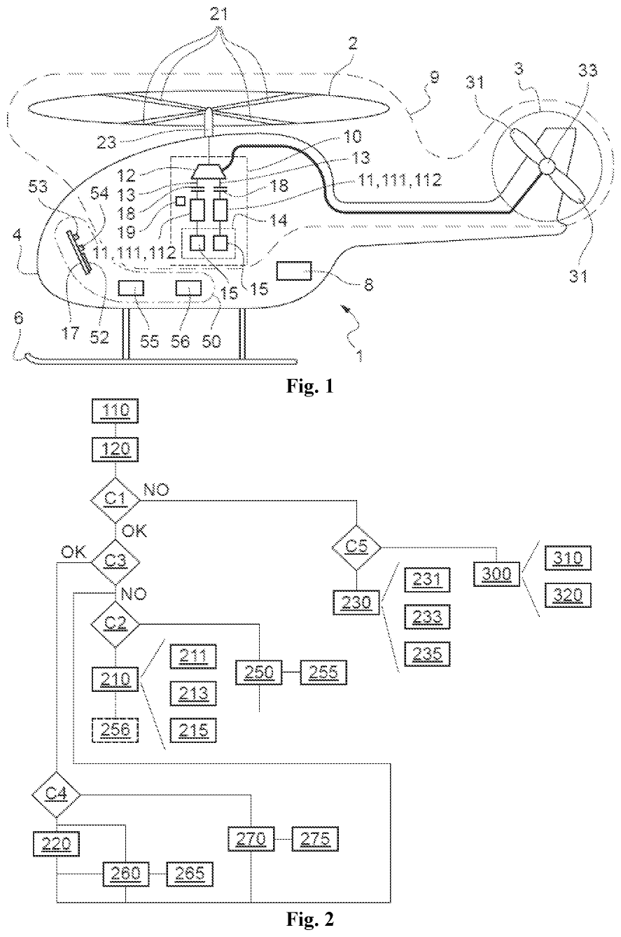

An aircraft 1 is shown in FIG. 1. The aircraft 1 shown is a rotary-wing aircraft comprising a fuselage 4, a landing gear 6, a power plant 10 and at least one rotor 2,3 rotated by the power plant 10. In the example shown, the aircraft 1 comprises two rotors 2,3, i.e., a main rotor 2 arranged above the fuselage 4 and a rear rotor 3 arranged on a tail boom of the aircraft 1. The power plant 10 and the rotors 2,3 form an assembly 9 that enables the aircraft 1 to move.

The power plant 10 comprises at least two heat engines 11, a controller 14 controlling the operation of the heat engines 11 and a mechanical transmission channel arranged between the heat engines 11 and the rotors 2,3. This mechanical transmission channel is provided, in particular, with a main gearbox 12. The main gearbox 12 comprises input shafts 13 that are each connected, mechanically and separately, to one of the heat engines 11, for example via a free-wheel. The example of a power plant 10 shown in FIG. 1 comprises two heat engines 11, but such a power plant 10 may comprise at least three heat engines 11.

The controller 14 may, for example, comprise as many engine controllers 15 as the power plant 10 comprises heat engines 11. Each engine controller 15 is connected to a respective heat engine 11, and can control and monitor the operation of this heat engine 11. Each engine controller 15 makes it possible, by means of sensors arranged on the heat engine 11, to measure propulsion parameters relating to the heat engine 11, such as torques and speeds of rotation at rotating members of this heat engine 11, internal temperatures of this heat engine 11, for example of a combustion chamber or compressor outlet, and margins relating to the performances of the heat engine 11, and in particular relating to the power that is actually available for the heat engine 11.

The propulsion parameters also comprise usage data of these heat engines 11. The usage data of each heat engine 11, for example its operating time or the number of cycles performed, are counted by an engine counter. The propulsion parameters may be stored in a memory of the engine controller 15.

The assembly 9 may comprise other sensors, that are not shown in FIG. 1 for the sake of clarity, for measuring propulsion parameters relating to the rotors 2,3, and to the mechanical transmission channel, in particular to the mechanical gearbox 12. These propulsion parameters comprise torques and speeds of rotation at respective masts 23,33 of the rotors 2,3, measured, for example, by means of torquemeters and tachometers, torques and speeds of rotation of rotating members of the mechanical transmission channel, for example at the input shafts 13, measured, for example, using torquemeters and tachometers, as well as usage data of the input shafts 13. The usage data of each input shaft 13, for example its operating time or the number of cycles performed, are counted by a transmission counter. These propulsion parameters relating to the rotors 2,3 and to the mechanical transmission channel may be stored in a memory 19 of the power plant 10.

Alternatively, the propulsion parameters may be stored in a dedicated memory or in a memory of an avionics system 8 of the aircraft 1.

This avionics system 8 may comprise or be connected to several sensors in order to measure operating parameters of the aircraft 1. These operating parameters comprise flight parameters relating to the aircraft 1, such as its forward speed, its rate of climb, its altitude, its attitude and/or its height in relation to the overflown ground, for example. These flight parameters of the aircraft 1 may, for example, be measured by means of tachometers, accelerometers, an inertial unit, a pressure altimeter or a radio altimeter.

These operating parameters may also comprise operational parameters of the aircraft 1. These operational parameters may comprise controlled pitch values of blades 21, 31 of the rotors 2,3, or a forward speed acceptable to the aircraft 1 in the economy operating mode. Such an acceptable forward speed is determined as a function of the power that is actually available for each heat engine 11. This acceptable forward speed may therefore be different depending on the heat engine 11 used.

These operational parameters may also comprise a state of equipment of the aircraft 1. Such a state characterizes whether or not each item of equipment is in a normal or nominal operating state, for example being in a normal or nominal mode, i.e., without a failure or malfunction and with normal performance, in a degraded mode, i.e., with a limited performance, or in a failed state. Such equipment of the aircraft 1 may comprise, for example, an electric motor, a starter or a starter-generator connected to a heat engine 11, or indeed an electric battery.

Finally, these operating parameters may comprise environmental parameters comprising traffic conditions around the aircraft and weather conditions. Traffic conditions comprise, for example, the state of the traffic in order to define whether or not it is significant, for example if the number of aircraft flying around the aircraft 1 is greater than a predetermined number. Weather conditions comprise, for example, measured values of an external temperature and an atmospheric pressure in an environment situated outside the aircraft 1. The weather conditions may comprise a wind speed value, a state characterizing the presence of rain or snow, or a state characterizing the visibility conditions, for example as being good or degraded.

The power plant 10 may implement several operating modes in order to drive the rotors 2,3. For example, in an AEO operating mode, the controller 14 controls the operation of the heat engines 11 so that all of the heat engines 11 are used and each supplies non-zero mechanical power to the rotors 2,3 such that they together supply, in a substantially symmetrical manner, the mechanical power required for the rotors 2,3 and the aircraft 1 to function correctly.

Alternatively, the controller 14 can control the operation of the heat engines 11 in such a way that at least one of the heat engines 11 is an active engine 111 supplying non-zero mechanical power to the rotors 2,3 in an economy operating mode. Each of the other heat engines 11 of the power plant 10 is a passive engine 112 that then supplies no mechanical power to the rotors 2,3 and does not contribute to their rotation. The purpose of this economy operating mode is to reduce the fuel consumption of the power plant 10, and consequently reduce the cost of a flight of the aircraft 1. The economy operating mode is particularly intended for cruising flight.

The economy operating mode may help make financial or fuel consumption savings, increase the range of the aircraft 1 for a given quantity of fuel, or increase the weight of the additional payload transported by the aircraft 1.

However, the flight envelope wherein the economy operating mode can be used is limited by several limitations. One such limitation may comprise an upper threshold, a lower threshold or a range to be respected, possibly using hysteresis thresholds. Such a limitation may also relate to a particular state. These limitations of the economy operating mode comprise functional limitations and safety limitations.

These safety and functional limitations may comprise at least one propulsion limitation relating to at least one propulsion parameter, at least one flight limitation relating to at least one flight parameter, at least one operational limitation relating to at least one operational parameter and at least one environmental limitation relating to at least one environmental parameter.

Moreover, the economy operating mode may comprise a single operating mode. Alternatively, the economy operating mode may comprise at least two different operating modes.

When the economy operating mode comprises at least two different operating modes, specific and different safety and functional limitations may be associated with each of these operating modes for a given operating parameter.

For example, flight limitations may comprise a safety height, that may be different for each economy operating mode, below which the aircraft 1 must not fly in the economy operating mode, or a minimum forward speed, conventionally referred to as Vy, that may be identical for each economy operating mode, below which the aircraft 1 must not fly in the economy operating mode. Hysteresis thresholds may be used for these flight limitations, for example with a 5% difference between the two thresholds. These two flight limitations are safety limitations.

Flight limitations may also comprise a maximum attitude of the aircraft 1, for example a maximum pitch angle and a maximum roll angle that are respectively equal to +/−10°. This flight limitation is functional. Indeed, the roll angle of the aircraft 1 may, for example, be increased temporarily when turning, without compromising flight safety.

Propulsion limitations may comprise minimum margins relating to the actual power that a heat engine 11 can supply or that the main gearbox 12 can transmit below which associated propulsion parameters must not lie. Such a minimum margin is equal to 1%, for example. These two propulsion limitations are safety limitations. Propulsion limitations are generally safety limitations, because they have a direct effect on keeping the aircraft 1 airborne.

Environmental limitations may comprise a maximum wind speed, that is a functional limitation. Environmental limitations may also comprise the presence of rain or snow, or the presence of significant traffic in the flight area. These environmental limitations are safety limitations.

Environmental limitations may also comprise the lack of visibility, the importance of which may be left to the pilot's discretion. Indeed, if the flight is taking place away from a busy traffic area and far from any relief or obstacle, this limitation may be a functional limitation. Otherwise, it may become a safety limitation. The environmental parameter relating to visibility may, for example, comprise two states, i.e., good visibility and degraded visibility, the associated environmental limitation being respected in the “good” state and not being respected in the “degraded” state.

Operational limitations may comprise the state of equipment of the aircraft 1, whether this equipment is hydraulic or electrical, for example. One such operational limitation is, for example, respected when an item of equipment is in a normal or nominal operating state and not respected when it is damaged or has failed. Depending on the equipment, such a limitation may be a functional and safety limitation. For example, if it relates to a redundant navigation device, and at least two are still functioning, the limitation may be functional. However, when only a single device remains functional, the limitation becomes a safety limitation.

Operational limitations may also comprise an upper limit of the increase in the controlled pitch values of blades of the rotors 2,3, the available power in economy operating mode not being compatible with an increase greater than this limit. This upper limit is equal to 3 degrees per second, for example. Hysteresis thresholds may be applied, a difference of 10% being able to separate the two thresholds, for example.

Operational limitations may also comprise a range relating to the forward speed that is acceptable in the economy operating mode, the forward speed needing to lie within this range in order for this limitation to be respected. Hysteresis thresholds may be applied, a difference of 2% being able to separate the two thresholds, for example.

Moreover, the aircraft 1 comprises a system 50 for controlling an economy operating mode of the aircraft 1. This control system 50 comprises a calculator 55, a memory 56 and a display device 52, such as a screen, for example arranged on an instrument panel 17 of the aircraft 1. The control system 50 may also comprise a loudspeaker 53 and a human-machine interface 54. The human-machine interface 54 may comprise any system that can be used by an individual, such as a touch screen panel or a knob with several positions, for example.

The calculator 55 of the control system 50 is connected to the controller 14 by a wired or wireless link. The calculator 55 is also connected, by a wired or wireless link, to the avionics system 8 and/or to different sensors of the aircraft 1, in order to receive operating parameters of the aircraft 1.

The control system 50 can be used to help the pilot of the aircraft 1 manage the operating modes, and the economy operating mode in particular. Indeed, the control system 50 is configured to implement a method for controlling an economy operating mode for the aircraft 1.

To this end, the memory 56 may store instructions and/or a computer program that make it possible, in particular, to carry out the control method, an overview diagram of which is shown in FIG. 2. The calculator 55 of the control system 50 makes it possible to carry out this method.

The control method comprises the following steps.

Firstly, during a measurement step 110, the operating parameters are measured using the different sensors. The measured values of these operating parameters may be transmitted, via a wired or wireless link, in the form of an electrical or optical signal, which may be digital or analog, to the calculator 55. The measured values of these operating parameters may also be transmitted to a memory for storage.

Next, during a comparison step 120, the measured values of these operating parameters are compared by the calculator 55 respectively with the safety and functional limitations relating to the economy operating mode and associated with these parameters, in order to verify whether each operating parameter respects the associated safety or functional limitation.

Following this comparison 120, and depending on whether or not the economy operating mode is being used, different steps may be performed.

If a condition C1 relating to the use of the economy operating mode is verified and if a condition C2 relating to whether the limitations are being respected concludes, following the comparison 120, that at least one functional limitation is not being respected, whereas the safety limitations are being respected, an alert is issued 210 to the pilot of the aircraft 1 indicating that the functional limitations of the economy operating mode have been exceeded. To this end, the calculator 55 sends an optical or electrical signal, which may be digital or analog, to the device issuing this alert.

This issuing 210 of such an alert indicating that limitations have been exceeded may comprise a step of displaying 211 a message on the display device 52. This message comprises information relating to the at least one operating parameter not respecting the associated functional limitation. This issuing 210 of such an alert indicating that limitations have been exceeded may also comprise a step of issuing 213 a sound by means of the loudspeaker 53 or emitting 215 a vibration by means of a haptic device arranged, for example, on a collective pitch control lever.

The pilot is thus informed of the failure to respect this functional limitation and may act on the controls of the aircraft in order to return to the flight envelope of the economy operating mode.

The pilot may also, for example by means of the human-machine interface 54, manually command the exit of the economy operating mode. The human-machine interface 54 then sends an optical or electrical signal, which may be digital or analog, carrying such a command to the controller 14.

A normal starting 256 of the passive engine or engines 112 may then be controlled by the controller 14 in order to disengage the economy operating mode. This normal starting 256 is performed with a first acceleration of this or these passive engines 112 effected during a first time period until this or these heat engines 11 supply non-zero mechanical power to the rotors 2,3, the power plant 10 then supplying the non-zero mechanical power to the rotors 2,3. The aircraft 1 is then, for example, in the AEO operating mode.

The operating parameter or parameters that do not respect the functional limitations are not modified, but the aircraft 1 then travels with several heat engines 11 supplying mechanical power to the rotors 2,3. The flight envelope is then extended and compatible with the values of these parameters.

Alternatively, semi-automatic operation of the control system 50 may have been pre-set by the pilot. In this semi-automatic operating mode, as soon as the alert indicating that limitations have been exceeded is issued 210, the normal starting 256 of the passive engine or engines 112 is automatically commanded and carried out by the controller 14.

Furthermore, if the condition C1 relating to the use of the economy operating mode is verified and if the condition C2 relating to whether or not the limitations are being respected concludes, following the comparison 120, that at least one safety limitation is not being respected, irrespective of whether or not the functional limitations are being respected, the economy operating mode is disengaged 250, the calculator 55 then sending an optical or electrical signal, which may be digital or analog, carrying such a command to the controller 14. During this disengagement 250, the passive engine or engines 118 are automatically activated 258 by means of the controller 14.

This disengagement 250 may comprise an accelerated starting 255 of the passive engine or engines 112 in order to disengage the economy operating mode.

The accelerated starting 255 is carried out by means of the controller 14 with a second acceleration of this or these passive engines 112, the second acceleration being carried out during a second time period until this or these heat engines 11 supply non-zero mechanical power to the rotors 2,3, the second time period being shorter than the first time period. Accelerated starting 255 therefore advantageously makes it possible to quickly start the passive engine or engines 112 in order to return the aircraft 1 to a safe flight envelope as quickly as possible.

Moreover, the economy operating mode may, for example, comprise two different operating modes. In a first operating mode, the passive engine or engines 112 are stopped and are not supplied with fuel. In a second operating mode, the passive engine or engines 112 are started and operate in an idle state.

In this case, specific flight envelopes may be associated respectively with the first and second operating modes. The flight envelope associated with the first operating mode is more restrictive than the flight envelope associated with the second operating mode. The limitations, whether they are functional or safety limitations, may then respectively comprise first limitations relating to the first operating mode and second limitations relating to the second operating mode.

The method according to the disclosure may then comprise steps specific to these two economy operating modes. For example, when a condition C3 relating to the use of the first operating mode is verified and if a condition C4 relating to whether or not the limitations are being respected concludes, following the comparison 120, that at least one first functional limitation is not being respected, whereas the first safety limitations are being respected, an alert is issued 220 to the pilot of the aircraft 1 indicating that the first functional limitations have been exceeded. To this end, the calculator 55 sends an optical or electrical signal, which may be digital or analog, to the device issuing this alert.

The pilot is thus informed of the failure to respect this first functional limitation and may act on the controls of the aircraft 1 to return to the flight envelope relating to the first operating mode. The pilot may also act, for example by means of the human-machine interface 54, to command the engagement 260 of the second operating mode. The stopped passive engine or engines 112 are then started by the controller 14, while remaining passive, i.e., without supplying mechanical power to the rotors 2,3. The human-machine interface 54 then sends an optical or electrical signal, which may be digital or analog, carrying such a command to the controller 14.

The operating parameter or parameters that do not respect the first functional limitations are not modified, but the aircraft 1 then travels in the second operating mode and in an extended flight envelope compatible with the values of these parameters.

Alternatively, semi-automatic operation of the control system 50 may have been pre-set by the pilot. In this semi-automatic operating mode, as soon as the alert indicating that the first functional limitations have been exceeded is issued 220, the engagement 260 of the second operating mode is commanded and carried out the controller 14.

Similarly, when the condition C3 relating to the use of the first operating mode is verified and if the condition C4 relating to whether or not the limitations are being respected concludes, following the comparison 120, that at least one first safety limitation is not being respected, and that the second safety limitations are being respected, irrespective of the first and second functional limitations, the second operating mode is engaged 270 by the controller 14. The stopped passive engine or engines 11 are then started by the controller 14, while remaining passive, i.e., without supplying mechanical power to the rotors 2,3.

The operating parameter or parameters that do not respect the first safety limitations are not modified, but the aircraft 1 then travels in the second operating mode and in an extended flight envelope compatible with the values of these parameters.

The method also comprises other steps in the event that the condition C1 is not verified, i.e., the aircraft 1 is not travelling in an economy operating mode.

Indeed, if the condition C1 is not verified and a condition C5 relating to whether or not the limitations are being respected, whether they are functional or safety limitations, is verified following the comparison 120, information relating to the availability of the economy operating mode is issued 230 by the calculator 15.

This issuing 230 of information relating to the availability of the economy operating mode may comprise a step of displaying 231 a message on the display device 52. This message comprises information indicating that the economy operating mode is operational. This issuing 230 of information relating to the availability of the economy operating mode may also comprise a step of issuing 233 a sound by means of the loudspeaker 53 or emitting 235 a vibration by means of a haptic device arranged, for example, on a collective pitch control lever.

Therefore, the pilot is informed that the economy operating mode can be used and may act, for example on the human-machine interface 54, to engage the economy operating mode. The human-machine interface 54 then transmits an optical or electrical signal, which may be digital or analog, carrying information to engage the economy operating mode to the controller 14.

This economy operating mode is then engaged 300 by the controller 14. This engagement 300 comprises a first control 310 of at least one of the heat engines 11 by means of the controller 14 so that it is an active engine 111 and supplies the required mechanical power to the rotors 2,3, and a second control 320 of at least one other of the heat engines 11 by means of said controller 14 so that it is a passive engine 112 supplying no mechanical power to the rotors 2,3. This second control 320 may comprise stopping or idling this at least one other passive engine 112.

Alternatively, semi-automatic operation of the control system 50 may have been pre-set by the pilot. In this semi-automatic operating mode, as soon as the information relating to the availability of the economy operating mode is issued 230, the economy operating mode is engaged 300 automatically by the controller 14.

Moreover, the calculator 55 can determine, using the propulsion parameters, and in particular the usage data relating to the heat engines 11 and to the mechanical transmission channel supplied respectively by the engine counters and by the transmission counters, which heat engine or engines 11 can be an active engine 111, and therefore which heat engine or engines 11 must be a passive engine 112. The calculator 55 can transmit information to the controller 14 relating to this or these heat engines 11 that are likely to be an active engine 111 supplying non-zero mechanical power to the rotors 2,3 in order to carry out the first control 310, and relating to this or these heat engines 11 that are likely to be a passive engine 112 not supplying any mechanical power to the rotors 2,3 in order to carry out the second control 320.

This information may in particular be used during the step of engaging 300 the economy operating mode in order to define the heat engines 11 to which the first control 310 and the second control 320 respectively need to be applied.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

What is claimed is:

1. A method for controlling an economy operating mode for an aircraft, the aircraft being provided with at least one rotor and at least two heat engines rotating the rotor(s), the aircraft having a controller configured to control the heat engines in at least the economy operating mode wherein at least one active engine from among the heat engines supplies non-zero mechanical power to the rotor(s) and at least one passive engine from among the other heat engines does not supply mechanical power to the rotor(s),
the method comprising the following steps:
measuring operating parameters of the aircraft by means of sensors;
using a calculator to compare the operating parameters of the aircraft with safety limitations and functional limitations relating to the economy operating mode, the safety limitations having a direct effect on the safety of the flight of the aircraft, the functional limitations having an effect on the operation of the aircraft and/or on the effectiveness of the economy operating mode;
if the aircraft is in the economy operating mode and at least one of the functional limitations is not being respected and the safety limitations are being respected, issuing an alert indicating that the functional limitations of the economy operating mode have been exceeded; and
if the aircraft is in the economy operating mode and at least one of the safety limitations is not being respected, automatically disengaging the economy operating mode, the automatic disengagement comprising the activation of the passive engine(s) by means of the controller,
wherein the method comprises normal starting and accelerated starting of the passive engine (s) in the economy operating mode;
the normal starting comprising a first acceleration of the passive engine(s) for a first time period, until it supplies non-zero mechanical power to the rotor(s);
the accelerated starting comprising a second acceleration of the passive engine(s) for a second time period, until it supplies non-zero mechanical power to the rotor(s), the second time period being shorter than the first time period;
the normal starting taking place following the issuing of an alert indicating that the functional limitations of the economy operating mode have been exceeded and if a pilot of the aircraft authorizes the disengagement of the economy operating mode by means of an interface; and
the accelerated starting being carried out during the activation.

2. The method according to claim 1,
wherein, if the aircraft is not in the economy operating mode and the safety and functional limitations are being respected by the operating parameters, the method comprises issuing information relating to the availability of the economy operating mode.

3. The method according to claim 1,
wherein, if the aircraft is not in the economy operating mode and the safety and functional limitations are being respected by the operating parameters, the method comprises engaging the economy operating mode, the engagement comprising a first control of at least one of the heat engines by means of the controller so that it is an active engine, and a second control of at least one other of the heat engines by means of the controller in order for it to be a passive engine, the second control comprising stopping or idling the other(s) of the heat engines.

4. The method according to claim 3,
wherein the calculator determines the active engine(s) and the passive engine(s) from among the heat engines in the economy operating mode, the calculator transmitting information to the controller relating to the active engine(s) for the first control and to the passive engine(s) for the second control.

5. The method according to claim 1,
wherein the issuing of an alert indicating that the functional limitations of the economy operating mode have been exceeded comprises a step of displaying a message on a display device of the aircraft, the message comprising information relating to the operating parameter(s) that do(es) not respect the associated functional limitation.

6. The method according to claim 1,
wherein the operating parameters of the aircraft comprise at least two parameters, including:
propulsion parameters relating to an assembly of the aircraft, the assembly comprising the heat engines, the rotor(s), and a mechanical transmission channel mechanically connecting the heat engines and the rotor(s), the propulsion parameters being chosen from torques and speeds of rotation at rotating members of the heat engines, a torque and a speed of rotation of a mast of the rotor(s), torques and speeds of rotation of rotating members of the mechanical transmission channel, internal temperatures of the heat engines, margins relating to performances of the heat engines, engine counters associated with the heat engines, each engine counter counting an item of usage data of one of the heat engines, and transmission counters associated respectively with shafts of the mechanical transmission channel mechanically connected respectively to the heat engines, each transmission counter counting an item of usage data of one of the shafts;
flight parameters of the aircraft chosen from a forward speed, a rate of climb, an altitude, an attitude, a height in relation to the overflown ground;
operational parameters of the aircraft, the operational parameters being chosen from controlled pitch values of blades of the rotor(s), a forward speed acceptable to the aircraft in the economy operating mode, a state of equipment of the aircraft, the state comprising at least two states from a “normal” operating state, a “stopped” state or a “malfunction present” state relating to the equipment; and
environmental parameters relating to traffic conditions around the aircraft and to weather conditions outside the aircraft.

7. The method according to claim 6,
wherein the safety limitations and the functional limitations together comprise:
at least one propulsion limitation relating to at least one of the propulsion parameters;
at least one flight limitation relating to at least one of the flight parameters;
at least one operational limitation relating to at least one of the operational parameters; and
at least one environmental limitation relating to at least one of the environmental parameters.

8. The method according to claim 1,
wherein the economy operating mode comprises a first operating mode wherein the passive engine(s) is/are stopped and not supplied with fuel and a second operating mode wherein the passive engine(s) is/are started and supplied with fuel.

9. The method according to claim 8,
wherein at least one of the functional limitations comprises a first functional limitation relating to the first operating mode and a second functional limitation relating to the second operating mode, the first functional limitation and the second functional limitation being associated with the same operating parameter, and, if the aircraft is in the first operating mode and at least one of the first functional limitations is not being respected and the second functional limitations are being respected, the method comprises:
issuing an alert indicating that the first functional limitations of the first operating mode have been exceeded; or
engaging the second operating mode if an interface has been actuated by a pilot of the aircraft, the engagement comprising starting the passive engine(s) by means of the controller without it supplying mechanical power to the rotor(s); or
issuing an alert indicating that the first functional limitations of the economy operating mode limitations have been exceeded, and engaging the second operating mode if the interface is actuated by the pilot.

10. The method according to claim 8,
wherein at least one of the safety limitations comprises a first safety limitation relating to the first operating mode and a second safety limitation relating to the second operating mode, the first safety limitation and the second safety limitation being associated with the same operating parameter, and the method comprises the following additional step:
if the aircraft is in the first operating mode and at least one of the first safety limitations is not being respected and the second safety limitations are being respected, engaging the second operating mode, the engagement comprising starting the passive engine(s) by means of the controller, without it supplying mechanical power to the rotor(s).

11. The method according to claim 1,
wherein the controller comprises as many engine controllers as the aircraft comprises heat engines.

12. A computer program comprising instructions that,
when the program is run, cause the method according to claim 1 to be implemented.

13. A system for controlling an economy operating mode for an aircraft provided with at least one rotor and at least two heat engines rotating the rotor(s), the aircraft having a controller configured to control the heat engines in at least the economy operating mode wherein at least one active engine from among the heat engines supplies mechanical power to the rotor(s) and at least one passive engine from among the other heat engines does not supply mechanical power to the rotor(s), the system comprising:
at least one calculator; and
at least one memory storing at least one database,
wherein the system for controlling an economy operating mode is configured to implement the method according to claim 1.

14. An aircraft,
wherein the aircraft comprises the system for controlling an economy operating mode according to claim 13.
